(19) United States
(12) Patent Application Publication
(10) Pub. No.: US 2026/0208139 A1
(43) Pub. Date: Jul. 23, 2026

(54) LABORATORY SCALE FLUID CATALYTIC CRACKING UNIT FOR CO-REFINING BIO-BASED FEEDSTOCKS

(71) Applicant: Rijksuniversiteit Groningen, Groningen (NL)

(72) Inventors: Songbo HE, Groningen (NL); Hero Jan HEERES, Groningen (NL); Robertus Hendrikus VENDERBOSCH, Enschede (NL)

(21) Appl. No.: 19/134,140

(22) PCT Filed: Dec. 13, 2023
(86) PCT No.: PCT/EP2023/085519

§ 371 Date: May 29, 2025

(30) Foreign Application Priority Data
Dec. 13, 2022 (NL) 2033716

(51) Int. Cl. B01J 8/38; C10G 11/18

(52) U.S. Cl. CPC B01J 8/382; C10G 11/182; B01J 2208/00761; B01J 2208/00982; B01J 2219/00011; C10G 2300/1011; C10G 2300/706

(57) ABSTRACT

The invention relates to a test unit, particularly for the study of catalysts in reactions involving at least one catalyst and at least one reagent, such as fluid catalytic cracking reactions. The test unit comprises a downer, separator, riser, catalyst regenerator, and optional catalyst buffer. Transport of the catalyst is performed by screw conveyors.

The invention relates to a test unit, particularly for the study of catalysts in reactions involving at least one catalyst and at least one reagent, as well as to a process for fluid catalytic cracking of a reagent using the test unit.

### BACKGROUND ART

Bio-based feedstock such as ‘bio-oil’ from fast pyrolysis of lignocellulosic biomass, has a high water and oxygen content and has to be further refined for the application as biofuels and bio-based chemicals, for example by using Fluid Catalytic Cracking (FCC) processes such as used in existing refineries.

However, the injection of bio-oil into a high-temperature reactor often causes rapid and serious blockage of the feeding system and reactor due to the polymerization of the reactive components in the bio-oil, which is a technical issue hindering industrial implementation. Most present FCC units are therefore not suitable for cracking of bio-oil. Moreover, the optimal parameters for cracking this relatively new feedstock, e.g. the most suitable catalyst, residence time, temperature, and optionally the mixing conditions with fossil fuels (co-refining) are not yet known and require testing.

Testing is for obvious reasons advantageously performed in lab-scale units. Lab-scale units (i.e. units which fit in a laboratory, such as units with a maximum height of 4 m) can however not be simple smaller copies of industrial scale units. Industrial FCC units comprise risers in which the cracking takes place. However, such riser units are several meters high, and cannot be downscaled as this would change the reaction conditions such as catalyst flow. The results acquired in a small riser unit such as the “MAT”-test, or Micro Activity Test are not representative of industrial processes.

Until now this “MAT”-test, according to ASTM D-3907, has been the primary tool for the laboratory evaluation of FCC. In this test, a small sample of catalyst is tested in a fixed bed setup. A very dilute sample is injected into the bed at a very high flow rate. Some of the drawbacks associated with the conventional MAT system are the long catalyst residence time in the reactor, which is not comparable to production scale processes, the development of temperature and coke profiles along the fixed catalyst bed, the collection of products during a certain time period, which gives an average conversion and product distribution with high contributions of early phase cracking, and the possibility of further reactions occurring during the stripping step.

Laboratory scale setups other than fixed bed setups are rare, but can be found. For example, U.S. Pat No. 7,378,059 B2 discloses a test unit for the study of catalysts in short contact time reactions between a catalyst and at least one reagent in a down transported flow reactor (downer). The feed being in the downwards direction has a series of advantages with respect to the classical configuration of a rising flow reactor (riser). Since the gas flow is not necessary to transport the feedstock through the reactor, the flow of gas may be considerably lower. Consequently, there are also no limitations on the density of the solids involved. The reactor can be as short as is desired without derogating the general circulation of the solids. Consequently, very short residence times of the catalyst and of the products in the reactor can be achieved. Finally, in a circulation in the downwards direction, much less back-mixing of the catalyst takes place and the flow is more like piston flow. This permits the residence time, both of the gas and of the solids, to be controlled with much greater reliability.

However, the reactor reported in U.S. Pat. No. 7,378,059 B2 comprises only one injector, which is not suitable for injecting and co-refining bio-oil. The reactor is not suitable for testing different residence times. Furthermore, the catalyst is loaded to the reactor by fluidisation with gas.

However, in such a case, the flow of the catalyst is difficult to control. The coking degree of the catalyst, which has been reported when using bio-oils, is very high as compared to fossil fuel, and such the catalyst is therefore even more difficult to transport, making the catalyst injection of U.S. 7,378,059 B2 less suitable in case bio-oil is used. Finally, the used catalyst is collected in a tank which does not provide the option of in situ multiple catalyst re-use.

### DESCRIPTION OF INVENTION

It is an objective of the present invention to provide a solution to the abovementioned drawbacks or at least to provide a useful alternative. It is a further objective of the present invention to provide a laboratory-scale FCC unit. It is a further objective of the present invention to provide an FCC unit that is suitable for the injection of bio-oil. It is a further objective of the present invention to provide an FCC unit that is suitable for catalytic co-conversion of bio-oil and fossil fuel. It is a further objective of the present invention to provide an FCC unit and process in which the catalyst loop of large-scale reactors can be mimicked. It is a further objective of the present invention to provide an FCC unit and process in which the catalyst is transported more effectively. It is a further objective of the present invention to provide an FCC unit and process which has a more uniform residence time distribution of catalyst particles as compared to a process in a riser unit. It is a further objective of the present invention to provide an FCC unit and process wherein the residence time of the FCC reaction is tunable.

Thereto, the present invention provides a test unit, particularly for the study of catalysts in reactions involving at least one catalyst and at least one reagent, comprising
a downer with
   a first inlet arranged in the upper part of the downer for loading a catalyst, such as a fresh catalyst, further regenerated catalyst or a buffered catalyst,
   a second inlet arranged in an upper part of the downer for loading a reagent, and
   an outlet arranged in a lower part of the downer for discharging the spent catalyst and reaction products,
   a heater for heating at least part of the downer, a separator with
   an inlet arranged in the upper part of the separator for loading the spent catalyst and reaction products from the downer, and
   a first outlet arranged in an upper part of the separator for discharging the reaction products separated from the catalyst, and
   a second outlet arranged in a lower part of the separator for discharging the separated catalyst,
a riser with
   an inlet arranged in a lower part of the riser for loading the separated catalyst from the separator,
   an outlet arranged in an upper part of the riser for evacuating the at least partly regenerated catalyst,
   a heater for heating at least part of the riser,
a catalyst regenerator with
   an inlet for loading the at least partly regenerated catalyst from the riser,
   a heater for heating at least part of the catalyst regenerator,
   an outlet for evacuating the further regenerated catalyst,
optionally a catalyst buffer with
   an inlet arranged in an upper part of the buffer for loading the further regenerated catalyst from the catalyst regenerator,
   a second inlet for loading fresh catalyst,
   an outlet arranged in a lower part of the buffer for evacuating the buffered catalyst.

The invention further provides a process for fluid catalytic cracking of a reagent, preferably using the test unit of the invention, the process comprising performing a fluid catalytic cracking reaction on at least one reagent with a catalyst in a downer, wherein the catalyst and reagent are loaded into the downer through separate inlets, separating the spent catalyst and reaction products in a separator, heating and thereby at least partly regenerating the spent catalyst in a riser, and further regenerating the at least partly regenerated catalyst in a catalyst regenerator, followed by analysis of the reaction products, the spent catalyst and/or the regenerated catalyst.

The invention also provides for the use of the test unit of the invention for determining optimal reaction conditions in a fluid catalytic cracking reaction involving at least one catalyst and at least one reagent

The test unit and process according to the invention provide several advantages over the disclosure of U.S. 7,378,059 B2 and the MAT test, as well as over prior art large scale processes.

First of all, catalyst regeneration requires high temperatures (e.g. >600° C.), which often causes a temperature jump on the catalyst bed. This leads to irreversible catalyst deactivation such as particle sintering and the loss of porosity and acidity. Pre-regenerating the deactivated catalyst at low temperatures (e.g., programmed from 200-500° C.) in the riser of the present invention can partially remove the coke and prevent the temperature jump.

Furthermore, a large number of catalyst regeneration-reaction cycles are required to obtain catalyst reusability information. This is time-consuming and labor-intensive. In the present invention, the catalyst loop of large scale reactors is mimicked and the catalyst performance and reaction-regeneration cycles can easily be tested.

Finally, in most (industry scale) units, the catalytic cracking is performed in a riser. The residence time distribution of catalyst particles in a riser is not very uniform due to size differences. In a downer reactor such as in the present invention, the residence time of the catalyst is more uniform, which results in a better understanding of catalyst deactivation behavior.

The downer of the present invention is preferably a tubular reactor, such as a stainless steel pipe or several connected stainless steel pipes. Preferably the downer is a tubular reactor with a height/diameter ratio of at least 5, particularly from 50 to 500. The diameter of the tubular reactor is preferably between 1.5-25 mm, more preferably between 3-12 mm, most preferably between 6-10 mm. The length of the downer is preferably between 0.2-2 m, more preferably between 0.3-1.5 m, most preferably between 0.5-1 m.

The riser (up transported flow reactor) is preferably a tubular reactor, such as a stainless steel pipe or several connected stainless steel pipes. Preferably the riser is a tubular reactor with a height/diameter ratio of at least 5, particularly from 50 to 1000. The diameter of the tubular reactor is preferably between 1.5-25 mm, more preferably between 3-12 mm, most preferably between 6-10 mm. The length of the riser is preferably between 0.5-3 m, more preferably between 1.0-2.0 m, most preferably between 1.2-1.8 m.

In a preferred embodiment, the length of the downer is adjustable. For example, in case the downer comprises stainless steel pipes, the downer may use quick connections to connect one or more stainless steel pipes of a defined length, such as e.g. a length of 25-50 mm. By using different numbers of pipes, the length is adjusted. As such, the overall height of the downer may be adjusted accordingly, and the residence time may be tuned.

In a preferred embodiment, the length of the riser is adjustable. For example, in case the riser comprises stainless steel pipes, the riser may use quick connections to connect one or more stainless steel pipes of a defined length, such as e.g. a length of 25-50 mm. By using different numbers of pipes, the length is adjusted. As such, the overall height of the riser may be adjusted accordingly, and the residence time may be tuned.

More preferably, the length of both the downer and the riser is adjustable, and in such a way that an increase or decrease in the length of the downer results in the same increase or decrease in the length of the riser. For example, both the downer and the riser may use quick connections to connect one or more stainless steel pipes of a defined length, such as e.g. a length of 25-50 mm. By using different numbers of pipes, the number of pipes being identical for the downer and riser, the lengths of the downer and the riser are adjusted simultaneously. As such, the overall height of the unit is adjusted accordingly, and the duration of the catalytic cracking reaction in the downer, as well as the catalyst pre-regeneration in the riser may be tuned.

Preferably, the downer comprises a third inlet arranged in an upper part of the downer for loading a reagent. In this case, the downer comprises at least two reagent inlets. This is advantageous for studying co-refining reactions of multiple reagents, for example co-refining of bio-oil and fossil fuel. Preferably, the third inlet is arranged downstream from the second inlet. This is particularly advantageous, in that each reagent can be loaded at a point from where the catalytic cracking reaction provides the highest yield. For example, the reagent that requires a longer residence time or more active catalyst may be loaded in the second inlet, and the reagent that requires a shorter residence time or less active catalyst may be loaded through the third (downstream) inlet. Preferably, the first inlet for loading a catalyst is the most upstream located inlet, even more preferably it is located at the top of the downer. In this way, catalyst is present at the point in the downer where the reagent(s) is/are loaded.

Preferably, the downer comprises on or more further inlets arranged in an upper part of the downer for loading a reagent. More preferably, the one or more further inlets are arranged consecutively downstream from the previously mentioned reagent inlets. Through the one or more further inlets, further reagents can be loaded for co-refining reactions with three or more reagents. Additionally or alternatively, upon using the test unit, not all inlets need to be used. The presence of the multiple inlets provides further options for tuning the reaction conditions. For example, the relative addition locations of co-refining reagents may be altered in different experiments, for defining the most effective location for adding each reagent. Furthermore, by using e.g. a more downstream reagent inlet, the residence time is reduced without having to adjust the length of the downer itself.

Preferably, at least one of the reagent inlets comprises an ultrasonic nebulizer. The difference between an ultrasonic nebulizer and traditional spray nebulizers, is that an ultrasonic nebulizer uses ultrasonic vibrations passing through a liquid to generate a very fine mist of the liquid, whereas a traditional nebulizer uses compressed air to generate a mist. The injection of bio-oil into a high-temperature reactor often causes rapid and serious blockage of the feeding system and reactor due to the polymerization of the reactive components in the pyrolysis oil. Spraying liquids in the downer reactor using an ultrasound spray nozzle / ultrasonic nebulizer generates very fine droplets capable of being vaporized rapidly followed by the immediate conversion over the catalyst thus preventing the agglomeration of char/coke in the reactor. The fine droplets generated by the ultrasonic nebulizer are preferably carried to the inlets of the downer by an inert gas such as nitrogen.

Preferably, the test unit comprises one or more screw conveyors (SC1-3) for feeding the catalyst to the first inlet of the downer, and/or the inlet of the catalyst buffer, and/or the inlet of the catalyst regenerator. Thus, preferably, the first inlet of the downer, and optionally the inlet of the catalyst buffer and optionally the inlet of the riser, are fed with catalyst via a screw conveyor. Flow of the catalyst is difficult to control, especially in the case of fluid catalytic cracking of bio-oil, because the coking degree of catalyst which has been used with bio-oil is very high as compared to fossil fuel, and such catalyst is therefore more difficult to transport. Feeding the solid catalyst continuously using a screw conveyor, has been shown by the present inventors to enable a fine control over the flow rate, even in the case of catalyst with a high coking degree. Due to the fine control over the flow rate, the process is overall very well controllable. Preferably, the screw conveyor(s) is/are operable at high temperatures, such as between 550-750° C., and at flow rates between 0.1-1.5 kg/h.

In the separator the spent catalyst is separated from the reaction products. The separator may for example be a stripper. The stripper is preferably a gas-solid fluidized bed stripper. Preferably an up-flowing gas, more preferably an inert gas, most preferably nitrogen removes product entrained in the down flowing stream of spent catalyst and reaction products. The separator thus preferably further comprises a second inlet arranged in a lower part of the separator for loading a gas, preferably an inert gas, such as nitrogen. The reaction products are thus entrained in the up-flowing gas, and may subsequently be led through a further separator, such as a metal mesh filter or a cyclone separator, preferably a cyclone separator. The further separator is connected to the outlet for discharging the reaction products in order to remove any fine solids entrained in the up-flowing gas, after which the reaction products may be condensed in a condenser and separator which is connected to the further separator. The reaction products may subsequently be analyzed.

The second outlet for discharging the separated catalyst from the separator is preferably connected to the inlet of the riser by a screw conveyor. The riser is equipped with a heater for heating at least part of the riser. Upon heating the riser at low temperatures (e.g. in the range of 100-700° C., preferably in the range of 150-600° C., more preferably in the range of 200-550° C.), the spent catalyst is pre-regenerated. Pre-regeneration can partially remove the coke and prevent a large temperature jump. Preferably the riser is equipped with multiple heaters, thereby defining heating zones along the length of the riser. In this way, for example, the different consecutive zones going from the bottom to the top of the riser may have an increasingly higher temperature. This particularly prevents the temperature jump which occurs when coke is directly oxidized at a very high temperature, such as a temperature of 750° C. For example, the bottom zone may have a temperature of between 100-200° C., and the top zone may have a temperature of between 600-700° C., and the temperature of the zones that are in between may be set accordingly. For example, in the case of 6 zones, the temperature of the consecutive zones may be 100-200° C., 200-300°C., 300-400° C., 400-500° C., 500-600° C., and 600-700° C. In the case of three zones, the temperature of the consecutive zones may for example be 100-300° C., 300-500° C., and 500-700° C.

The riser preferably further comprises a second inlet arranged in a lower part of the riser for loading a regenerating gas, such as a gas comprising oxygen, e.g. air or air which has been diluted with an inert gas. In the latter case, the low oxygen partial pressure aids in preventing the temperature jump.

The outlet for evacuating the at least partly regenerated catalyst from the riser is preferably connected to the inlet of the catalyst regenerator by a screw conveyor as described above. The catalyst regenerator may be a fixed bed reactor, but is preferably a fluidized bed reactor. The outlet for evacuating the further regenerated catalyst is connected, preferably via a screw conveyor, either to the inlet of the catalyst buffer, or to the first inlet of the downer.

The catalyst buffer may be a fixed bed reactor, but is preferably a fluidized bed reactor. Via the second inlet, fresh catalyst may be loaded into the catalyst buffer for mixing with the regenerated catalyst. Via the outlet arranged for evacuating the buffered catalyst and an optional screw conveyor, buffered catalyst may be loaded to the downer, e.g. via the first inlet of the downer.

The catalyst regenerator preferably further comprises a second inlet arranged in a lower part of the catalyst regenerator for loading a regenerating gas, such as a gas comprising oxygen, e.g. air.

The catalyst buffer preferably further comprises a second inlet arranged in a lower part of the catalyst buffer for loading a gas, preferably in inert gas, e.g. nitrogen.

Preferably, the test unit comprises at least one catalyst sampling point. More preferably, the test unit comprises multiple catalyst sampling points. In this way the condition of the catalyst may be analysed at different points in the process. Preferably, a catalyst sampling point is located on at least one screw conveyor. Preferably all screw conveyors of the test unit comprise a catalyst sampling point.

Preferably, the maximum height of the test unit is 3-6 m, more preferably 3-5 m, more preferably 3-4 m, such that the test unit will fit in a typical laboratory environment.

The test unit of the present invention provides multiple options for tuning reaction conditions and analyzing the influence of these reaction conditions. For example, the reaction temperature in the downer, as well as the pre-regeneration temperature in the riser and the regeneration temperature in the catalyst regenerator may be tuned by accordingly setting the respective heaters to suitable temperatures. The preferred embodiments provide further options for tuning the reaction conditions as described.

In the process according to the invention, the fluid catalytic cracking reaction is preferably performed at a temperature of between 400 and 700° C., more preferably between 450 and 650° C., and most preferably between 500 and 600° C. After the reaction in the downer, the spent catalyst and the reaction products enter the separator where the reaction products are separated from the spent catalyst and removed from the reaction cycle, whereas the spent catalyst is fed to the riser, where the spent catalyst is partly regenerated, preferably at a temperature of between 100 and 700° C., more preferably between 150 and 600° C., and most preferably between 200 and 500° C. The partly regenerated catalyst is fed to the catalyst regenerator, where it is further regenerated, preferably at a temperature of between 600 and 850° C., more preferably between 650 and 800° C., and most preferably between 700 and 750° C. The regenerated catalyst may be stored in the catalyst buffer and is optionally reused in another process according to the invention.

Thus, preferably the process according to the invention comprises repeating the process with fresh reagent and the regenerated catalyst one or more times, optionally followed by analysis of the reaction products, the spent catalyst and/or regenerated catalyst.

The process may further comprise repeating any or all of the abovementioned process and analysis steps with fresh reagent and optionally with fresh catalyst, and feeding at least one reagent trough a different inlet.

The process may further comprise repeating any or all of the abovementioned process and analysis steps with fresh reagent and optionally with fresh catalyst, while the downer has a different length.

The test unit is suitable for studying the fluid catalytic cracking of many types of reagents. Preferably, at least one reagent is a bio-based feedstock, more preferably a bio-oil, most preferably bio-oil from fast pyrolysis of lignocellulosic biomass, such as pinewood and/or lignin. Preferably, the fluid catalytic cracking is performed on at least 2 reagents at the same time, preferably a bio-oil and a fossil fuel, wherein each reagent is loaded into the downer through a separate inlet.

The catalyst may be any type of catalyst suitable for fluid catalytic cracking. Preferably, the catalyst is chosen from the group consisting of zeolites, Al₂O₃, and noble metals such as Pt and Pd.

The invention further relates to use of a screw conveyor for transporting coked catalyst in a test unit for the study of catalysts in reactions involving at least one catalyst and at least one reagent, preferably wherein transport is from a separator to a riser.

### BRIEF DESCRIPTION OF THE FIGURE

FIG. 1 is a schematic image of a test unit according to combined preferred embodiments of the invention.

### DETAILED DESCRIPTION OF THE FIGURE

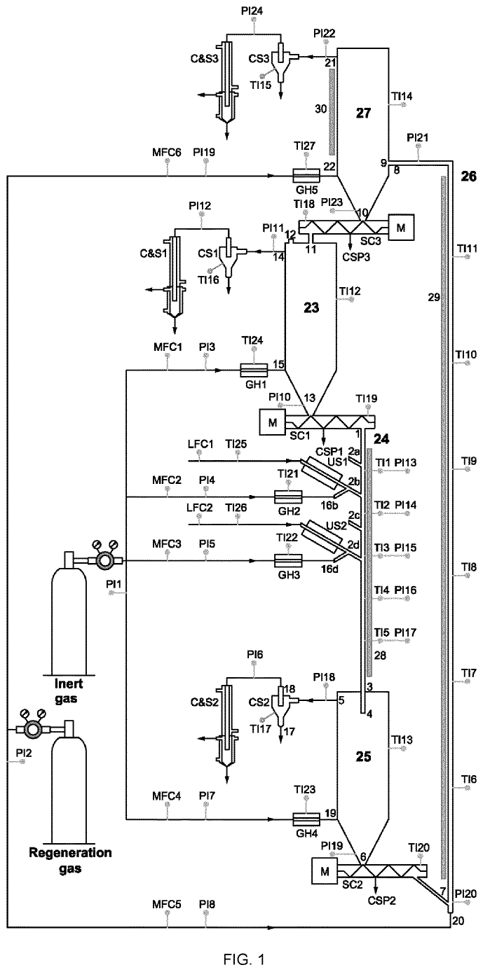

FIG. 1 discloses a test unit, which comprises a catalyst buffer 23, downer 24, separator 25, riser 26, and catalyst regenerator 27.

The catalyst buffer 23 may be a fluidized bed reactor. The catalyst buffer 23 further comprises an outlet 14 arranged in an upper part of the catalyst buffer 23 for evacuating any gases released during the buffering. These may be fed to a further separator CS1, such as a cyclone separator, which is further coupled to a condenser and separator C&S1. The catalyst buffer 23 preferably further comprises a second inlet 15 arranged in a lower part of the catalyst buffer 23 for loading a gas, preferably an inert gas, such as nitrogen. The catalyst buffer 23 comprises an outlet 13 arranged in a lower part of the buffer for evacuating the buffered catalyst into the upstream end of a screw conveyor SC1. Via the screw conveyor SC1, the buffered catalyst may be loaded to the upper end of the downer 24.

Reagents may be loaded into the downer 24 through different inlets 2a, 2b, 2c, and/or 2d. The inlets 2a-d may be each equipped with an inert gas inlet 16 and ultrasonic nebulizers US. Inert gas may be pre-heated by respective gas heaters GH. After the fluid catalytic cracking reaction, the reaction products and spent catalyst are discharged through the outlet 3 of the downer 24 into the inlet 4 of separator 25.

The separator 25 may be a fluidized bed reactor. The separator 25 comprises an outlet 5 arranged in an upper part of the separator 25 for discharging the reaction products. These may be fed to a further separator CS2, such as a cyclone separator. The further separator CS2 comprises a lower outlet 17 for separated solids, such as fine catalyst particles, and an upper outlet 18 for reaction products, which may be led through a condenser and separator C&S2 for condensing the reaction products and separating these from the incondensable gases, such as the inert gas. The separator 25 preferably further comprises a second inlet 19 arranged in a lower part of the separator 25 for loading a gas, preferably an inert gas, such as nitrogen. The separator 25 further comprises an outlet 6 arranged in a lower part of the separator 25 for evacuating the spent catalyst into the upstream end of a screw conveyor SC2. Via the screw conveyor SC2, the spent catalyst may be loaded to the inlet 7 of the riser 26.

The riser 26 further comprises an inlet 20 arranged in a lower part of the riser 26 for loading a regenerating gas. The riser 26 further comprises an outlet 8 arranged in an upper part of the riser 26 for evacuating the at least partly regenerated catalyst, which outlet is connected to the inlet 9 for loading the at least partly regenerated catalyst to the catalyst regenerator 27.

The catalyst regenerator 27 further comprises an outlet 21 arranged in an upper part of the catalyst regenerator 27 for evacuating any gases released during the regeneration of the catalyst. These may be fed to a further separator CS3, such as a cyclone separator, which is further coupled to a condenser and separator C&S3. The catalyst regenerator 27 preferably further comprises a second inlet 22 arranged in a lower part of the catalyst regenerator 27 for loading a regenerating gas, such as a gas comprising oxygen, e.g. air. The catalyst regenerator 27 further comprises an outlet 10 arranged in a lower part of the catalyst regenerator 27 for evacuating the regenerated catalyst into the upstream end of a screw conveyor SC3. Via the screw conveyor SC3, the regenerated catalyst may be loaded to the inlet 11 of the catalyst buffer 23.

The test unit comprises several pressure indicators PI and temperature indicators TI for monitoring the reaction conditions. The test unit furthermore comprises several liquid flow controllers LFC and gas mass flow controllers MFC. Gases and/or reaction products leaving the respective outlets of the separator 25, the catalyst regenerator 27, and the catalyst buffer 23 may be analysed. Catalyst at different stages of the reaction may be removed from sampling points CSP for analysis.

### LIST OF REFERENCES

23 Catalyst buffer
24 Downer
25 Separator
26 Riser
27 Catalyst regenerator
GH gas heater
LFC liquid flow controller
MFC mass flow controller
US ultrasonic spray
PI pressure indicator
TI temperature indicator
SC screw conveyor
CS separator
CSP catalyst sampling point
C&S condenser and separator

1. A test unit, particularly for the study of catalysts in reactions involving at least one catalyst and at least one reagent, comprising:
a downer with
a first inlet arranged in an upper part of the downer for loading a catalyst, such as a fresh catalyst, further regenerated catalyst from a catalyst regenerator or a buffered catalyst from a catalyst buffer, via a screw conveyor,
a second inlet arranged in an upper part of the downer for loading a reagent, and
an outlet arranged in a lower part of the downer for discharging the spent catalyst and reaction products, and
a heater for heating at least part of the downer,
a separator with
an inlet arranged in an upper part of the separator for loading the spent catalyst and reaction products from the downer, and
a first outlet arranged in an upper part of the separator for discharging the reaction products separated from the catalyst, and
a second outlet arranged in a lower part of the separator for discharging the separated catalyst,
a riser with
an inlet arranged in a lower part of the riser for loading the separated catalyst from the separator via a screw conveyor,
an outlet arranged in an upper part of the riser for evacuating the at least partly regenerated catalyst, and
a heater for heating at least part of the riser,
the catalyst regenerator with
an inlet for loading the at least partly regenerated catalyst from the riser,
a heater for heating at least part of the catalyst regenerator, and
an outlet for evacuating the further regenerated catalyst,
optionally the catalyst buffer with
an inlet arranged in an upper part of the catalyst buffer for loading the further regenerated catalyst from the catalyst regenerator via a screw conveyor,
optionally a second inlet for loading fresh catalyst, and
an outlet arranged in a lower part of the catalyst buffer for evacuating the buffered catalyst,
the test unit comprising multiple catalyst sampling points.

2. The test unit according to claim 1, wherein the length of the downer is adjustable.

3. The test unit according to claim 1, wherein the downer comprises a third inlet arranged in an upper part of the downer for loading a reagent.

4. The test unit according to claim 1, wherein the downer comprises one or more further inlets for loading a reagent arranged in an upper part of the downer.

5. The test unit according to claim 1, wherein at least one of the reagent inlets comprises an ultrasonic nebulizer.

6. The test unit according to any one of the preceding claim 1, wherein one or more of the screw conveyors are operable at temperatures between 550-750° C., and at flow rates between 0.1-1.5 kg/h.

7. The test unit according to claim 1, wherein all screw conveyors of the test unit comprise a catalyst sampling point.

8. A process for fluid catalytic cracking of a reagent using the test unit of claim 1, the process comprising performing a fluid catalytic cracking reaction on at least one reagent with a catalyst in a downer, wherein the catalyst and reagent are loaded into the downer through separate inlets, separating the spent catalyst and reaction products in a separator, heating and thereby at least partly regenerating the spent catalyst in a riser, and further regenerating the at least partly regenerated catalyst in a catalyst regenerator, followed by analysis of the reaction products, the spent catalyst and/or the regenerated catalyst.

9. The process according to claim 8, further comprising repeating the process with fresh reagent and the regenerated catalyst one or more times, optionally followed by analysis of the reaction products, the spent catalyst and/or regenerated catalyst.

10. The process according to claim 8, wherein at least one reagent is a bio-based feedstock.

11. The process according claim 8, wherein the fluid catalytic cracking is performed on at least 2 reagents at the same time, preferably a bio-oil and a fossil fuel, wherein each reagent is loaded into the downer through a separate inlet.

12. The process according to any one of claim 8, further comprising repeating the process with fresh reagent and optionally with fresh catalyst, and feeding at least one reagent through a different inlet.

13. A use of the test unit of any one of claims 1 1, for determining optimal reaction conditions in a fluid catalytic cracking reaction involving at least one catalyst and at least one reagent.

14. (canceled)

15. (canceled)

16. The test unit according to claim 1, wherein the test unit is a lab-scale test unit.

17. The test unit according to claim 1, having a maximum height of 3-6 m.
